(19) United States
(12) Patent Application Publication
(10) Pub. No.: US 2014/0308640 A1
(43) Pub. Date: Oct. 16, 2014

(54) Method to Improve Skilled Motion Using Concurrent Video of Master and Student Performance

(71) Applicants: George Edward Forman, Amherst, MA (US); Judith Barker Dixon, Amherst, MA (US)

(72) Inventors: George Edward Forman, Amherst, MA (US); Judith Barker Dixon, Amherst, MA (US)

(21) Appl. No.: 14/316,172

(22) Filed: Jun. 26, 2014

Related U.S. Application Data
(60) Provisional application No. 61/957,548, filed on Jul. 8, 2013.

(51) Int. Cl. G09B 19/00

(52) U.S. Cl. CPC G09B 19/00
USPC 434/258

(57) ABSTRACT

A method to improve a skilled motion through holistic viewing, in-place and/or across a horizontal plane, involving a video camera, computer, and monitor system that displays a prerecorded video clip of a master's performance selected from a library of video clips recorded in a plurality of perspectives and also displays a live video feed of the student performing the master's motion in the same perspective, controlled by placement of the video camera relative to the student. Slight variations of the master's skilled motion loop repeatedly and contain blacked-out segments such that the student dynamically performs the selected motion both with and without the visual guidance of the master's performance. The video library includes invention-specific tutorials on why to use specific digital video playback controls known to the art such as horizontal orientation, freeze frame, slow motion, as well as recording the live video to disk.

### CROSS-REFERENCE TO RELATED APPLICATIONS

This application claims priority to provisional application Ser. No. 61/957,548 filed Jul. 8, 2013, entitled “A video projection system for student athletes to view real time video of self adjacent to pre-recorded video of a coach.”

### STATEMENT REGARDING FEDERALLY SPONSORED RESEARCH AND DEVELOPMENT

This invention was made without benefit of federally sponsored research or development.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention relates to a method of projecting video images of a skilled motion. More particularly, the invention relates to displaying and viewing concurrent video of a master and a student, such that improvement of the execution of that motion results from a holistic comparison of each performance to the other, for skilled motions including, but not limited to, motions that translocate across the ground, floor, or court.

Participation in many sports and other forms of skilled motions involves repeating the components of the skilled motion over and over until a form of automaticity or motor memory develops that becomes a reliable guide to future performance. Different methods have been found to help students improve the skill and efficiency of motions, many of which use video and computing technology.

These methods vary in terms of which aspects of learning are emphasized and the class of motions to which they are useful. Some methods simply offer a student a video of a master performing a motion, such as a golf or tennis swing, with voice or text to point out critical angles and motions for the student to remember (see FIG. 1). This method suffers from that fact that the student does not try the motion while watching the master. Thus, the visual information of the master must be held in memory as the student tries to match in action what he saw some time before.

Other methods present a video of a master in a manner that encourages the student to shadow what the master is doing as the student watches the master. This method suffers from the inherent difficulty of receiving reliable visible information on what the student's body is doing when some motion components move out of the student's visual field, such as the form of the back swing while executing a forehand stroke in tennis.

There have been attempts to provide the student with video images of herself concurrently with a template or otherwise enhanced video of the master. In some cases, the video of the master is superimposed on the live video of the student (see Burns U.S. Pat. No. 5,904,484; O'Leary U.S. Pat. No. 5,904,484). However, in these prior inventions the system of calibrating the overlap of the two video images makes such a system useless for motions where the whole body moves across a horizontal plane, forward or sideways, such as a tennis player stepping forward to execute a forehand stroke or a dancer moving across the floor.

One might think that a student could watch a video of the master in a monitor that is placed in front of a mirror that allows the student to see both herself as well as the performance of the master. Such a system might work for lateral movements as well as movements in place, but would not allow the student to clearly see perspectives other than a frontal perspective. The use of multiple mirrors presents a geometric problem to assure that the student stays centered in the target mirror, nor do mirrors allow manipulation of scale or orientation to improve the viewing experience.

There are systems that present static images in a sequence that show how the master would execute a sequence of the components involved in a skilled motion or present numbers or graphics that quantify movement parameters such as angular rotation, acceleration, and relative locations (see Mengoli U.S. Pat. No. 6,514,081 B1). These systems, generically termed video analysis, suffer in two ways. The student learns what he or she did wrong but still has to map this information into a reliable motor sequence. This mapping is done by trial and error until the actual performance ultimately produces the same numbers as are specified as optimal numbers based on the physics of the art. Such a mapping is difficult because, in most cases, the feedback is not concurrent with the student's performance (see again FIG. 1) and the student has to translate the quantified or graphic indicators into an improved action pattern.

Even if the results of video analysis do appear during the execution of the motion, the student faces a second weakness of this method. The student develops a mindset to focus primarily on specific motion components that deviate from optimal numerical or graphic parameters. Such an analytic focus on one component, then another, then another interferes with a mindset to simply observe the flow and form of the motion as a whole. While this type of component analysis might be useful, it does not fully support the finesse and flexible application of skill that is required in the field, e.g., executing a forehand stroke in a tennis match. Indeed, the experience of working in these data-intensive environments can be overwhelming.

Many of these systems have the student study a discrete motion, such as to swing a golf club once, analyze, then swing the golf club again. While such systems are useful for diagnosing deviations from an optimal swing, here again such an approach interferes with developing a strong motor memory for the whole form of the movement, that is, holistic learning is more likely to occur by high frequency repetitive shadowing of the master's motion observed in a continuous loop.

It is the object of the invention to provide a method of improving a skilled motion that overcomes some of the disadvantages discussed above. These improvements include a means to support a more holistic mindset to learning a skilled motion by high frequency shadowing of the desired motion, as well as a means to assure that motor memory is not falsely treated as identical to what the student sees the master do.

### BRIEF SUMMARY OF THE INVENTION

Many instructional systems present the student with a plurality of data representing different critical components of either or both the student's performance and the master's performance of a desired motion, such as angular rotation, acceleration, plane of action, and other parameters dealing with a golf ball (or tennis ball) as it makes contact with a club (or a racket). These systems in general constitute a form of learning several components to be integrated later. The student uses the data from his own performance compared to the master's performance to focus on any one of the plurality of motion components that show a deviation sufficient to justify which action component to practice. Improvement results from perfecting each component, starting with those that show the greatest deviation from the master's performance of that component. The challenge in learning individual motion components comes from the difficulty inherent in the student's task to reassemble the component skills into a fluid motion that can be reliably reproduced on demand and in slightly different forms, as occurs during match play of a sport, for example.

Video analysis systems that provide motion data concurrent with performance of the student are not suited for motions that involve whole body movements across the horizontal plane of the playing surface (e.g., executing a tennis stroke on a tennis court) in addition to the movement of the limbs. For one, the amount of data needed to sufficiently display the critical variables for an ideal version of the desired movement would be too complex and overwhelming for the student to process concurrently to his own performance and more than likely also too complicated to put to good use during the student's performance after the data has been viewed. For another, the data that represents an optimal form of the movement for one execution of the desired movement would not necessarily be the same as another set of data for a second and equally optimal execution of the desired movement.

The present invention constitutes another form of learning, learning by differentiation, in which the student studies the total form of the movement in a manner that its components are treated as smooth transitions from moment to moment without the display of numerical measures of isolated motion components. The student watches the master in a situation similar to a dancer watching a choreographer teaching a new movement by dancing in front of a mirror in which the student sees himself as well as the choreographer. In this approach, improvement results from an orientation to the master's movement as total shape and pace. The student initially does not think about any particular motion component even though components gradually become differentiated and discernable as isomorphic to the standard displayed by the master. Initially the student is discouraged from thinking in words about particular angles or positions of the body but is told to repeatedly shadow the form and flow of the master's movement while maintaining a non-verbal mindset.

In this method the student on his own discovers the components that deviate from the master's performance based on what makes sense to the student as opposed to what is prescribed by quantified measures as mentioned above. The student improves performance by the development of motor memory that is guided by visual memory of the total form and flow. The motor memory controls performance automatically (non-verbally) due to the raw repetition of practicing the motion form, concurrently guided by the visual information from the master's motion and the student's dynamic shadowing of the master's motion. When performance is controlled by an initial and strong visual memory for the total form and flow of the desired motion, the student will perform the movement with more finesse and efficiency without undoing the form and flow of the desired motion and the student will more likely be able to reestablish the optimal total form of the motion even if the student's focus temporarily shifts to an isolated motion component, a shift that usually undoes the finesse.

The invention includes both a visualization system and a method of instruction. The visualization system includes side-by-side video windows, one of a live video stream of the student performing the skilled motion and one of the master performing the expert version of the skilled motion to be emulated by the student. The student dynamically practices the skilled motion while visually comparing his own performance to that of the master.

The method of instruction derives from the proposition that the evolution from novice to expert needs to come from a strong visual and proprioceptive (awareness of one's own body positioning) memory of the optimal motion. In particular, the student needs to recall a visual memory that is well mapped to the proprioceptive memory. It is the absence of this close mapping between what the student sees and what the student feels that increases the likelihood that the student will continue to move in a form that does not match the ideal motion.

Given that you cannot see all of what you do, you must feel the correct form of what you are doing in order to adjust and perform well. You cannot feel what the master does, so you must be sure what you feel is the form you see the master do. Using the visualization system and instructional method of the invention, students learn to feel the forms that they see. Furthermore, they are able to see in the video what they cannot see with their own eyes, given that the video of both the student and the master presents angles from the side, rear and even aerial perspectives. This presentation system is laid out in FIG. 3.

The instructional method includes a library of prerecorded video clips of a master performing a plurality of skilled actions in a variety of camera perspectives. The selected video clip automatically loops allowing the student to practice by shadowing the master's movements as many times as the student desires.

As the student continuously shadows the movement presented in the prerecorded video of the master, the student eventually begins to feel that he is creating the movement of the master. This inversion of attitude comes when the student begins to automate the control of muscular movements and is no longer thinking analytically of the components of the movement. However, this inversion could come from a false sense of isomorphism, a disjunction, between the student's movement and the master's movement.

To further mitigate the onset of this false sense of isomorphism between the master's movement and the student's performance, depicted as elements 301 and 307 in FIG. 3, the student is instructed, via a video tutorial to this method, to alternate attention between the video window of the master and the video window of the self. To further enhance the close mapping of the student's movement (307) to the master's movement (301), the pre-recorded video will have ten to twenty seconds of blank video before it loops back to the beginning to display the master's movements again. During the period of the blacked-out video of the master, the student will execute the desired motion while looking only at the live video of himself. In this manner the student will more likely see some awkwardness of his own performance that he mistook as well-done when the master's performance was visible, thereby mitigating the possibility that the student will falsely believe that he is doing (307) what the master is doing (301). The blacked-out period of the master's movement forces the student to recognize discrepancies in the form and flow of his movement compared to the master's movement. The frequency of the blacked-out period of the master's movement also insures that the false sense of isomorphism to the master's movement does not persist to the point at which the incorrect form of the movement becomes a form of automatic motor memory.

The instructional method provides additional factors that assure its success in perfecting the student's development of a practice such that the optimal form and flow of the movement become part of the automatic motor memory. One, the video of the master's movement will loop repeatedly to allow the student repeated exposure to and practice of the total form and flow of the desired movement.

Two, the student, in shadowing what he sees in the video of the master's motion, does not focus on the effects of his motion (e.g., hit a tennis ball), but only moves the body in the same form and flow as does the master who executes the motion with visible effects (e.g., does hit a tennis ball). In this way the student gives her full attention to the form and flow of the motion and not to the resulting effects, e.g., flight of the ball. When a student practices a motion, her attempt to divide attention between the movement of the body and the anticipated effects (e.g., flight of a ball) will degrade the quality of the student's concentration on the movement of the body and increase the possibility of imperfect practice of the total form of the motion.

Three, the prerecorded video clip of the desired movement shows at least three real time, successive and continuous executions of the same motion with all the accompanying subtle variations that the master executes during play, variations that, as a collection, represents what those in the art call expertise. Thus the student does not come away thinking that the optimal motion has an absolute form, even though it does have a general form that defines the motion as a class of motions that vary with the conditions of play.

Four, the blacked-out portion of the master's movement prior to looping gives the student the chance to compare the mental image of the master's movement with the video image of the self attempting to perform that master's movement. The student is not asked to view two video images superimposed, the master's movement superimposed over the student's movement. The flaws of superimposing images has been previously mentioned in that such a system reinforces the mindset that there is an absolute form to be emulated instead of a core form that varies slightly with variations in conditions (e.g., the feed of the ball). That is, when comparing a mental image of the master's movement with a current video display of the student's own movement, the student in effect is comparing what he remembers of the master's movement. This memory, of course, can be incomplete, but that is the point. The visual memory of the master's movement needs to be improved as well as the motor memory of the form and flow the student has of his own movement.

The invention is based on the learning principle that expertise emerges from the construction not only of an improved motor memory of the desired movement but also an improved visual memory of the master's movement. Indeed, it is this ability to retrieve the correct visual memory of the master's movement that allows a player to correct a series of unforced errors during match play. In such instances, the accomplished player will retrieve the visual memory of the master's movement to make, on the court, for example, adjustments of the tennis strokes that have degraded temporarily.

The student has the option to view different perspectives of the desired movement displayed on video screen or monitor. Each skilled motion, a tennis stroke, for instance, can be viewed in the front, rear, right side, left side, aerial and macro shots of the master performing the skilled motion. These perspectives are not the result of a four camera shoot of a single performance of the motion. Thus the variations in perspective are also variations in specific acts that exemplify the desired form and flow of the motion. These variations further insure that the student will not seek to replicate an absolute form of the desired movement but will seek to abstract the core form and flow of the motion, e.g., a forehand stroke in tennis.

Such a system of varied examples is especially important for athletic movements, such as tennis strokes, that are not performed in place swinging at a stationary ball, such as golf swings. Rather, as in the case of tennis, and other motions, the player has to translocate, set, and swing—moving her whole body laterally across the court. A system of video analysis or video feedback that provides the student with data or an image that is to be taken as an absolute guide to perfect performance (of a specific tennis stroke, in this case) would be misleading for athletic movements that, by their nature, differ within their class of variations.

The students has the option to select video footage of the master executing the skilled motion either as a right-handed motion or a left-handed motion. Furthermore, the computer interface allows the student to use the standard feature of most digital video players to horizontally flip the image of the live video feed of himself. With these choices the student can set the two video images (FIGS. 4, 401 and 402) to be optimally readable without requiring the student to mentally transpose an orientation that is not a mirror image. The student can also play the clips of the master at half speed.

The student can also screen-capture the entire screen with both video streams (406 and 409) for later viewing from a storage device.

### BRIEF DESCRIPTION OF THE SEVERAL VIEWS OF THE DRAWINGS

One or more embodiments of the invention will be described below by way of example only, and without intending to be limiting, with reference to the following drawings, in which:

FIG. 1 shows the timing of visual and proprioceptive feedback when the student watches a video of the performance of a skilled motion by a master before but not during student performance that occurs later.

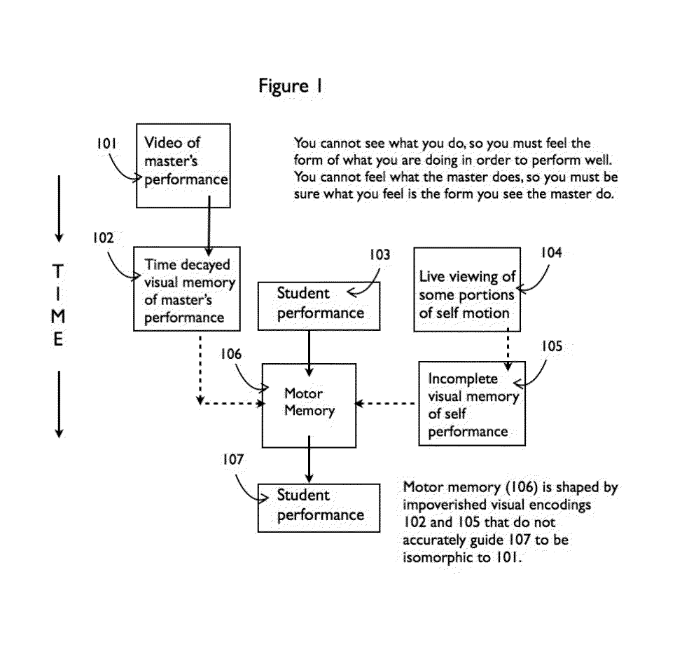

FIG. 2 shows the timing of visual and proprioceptive feedback when the student watches a video of a master while simultaneously performing the skilled motion without aid of a live video of the self.

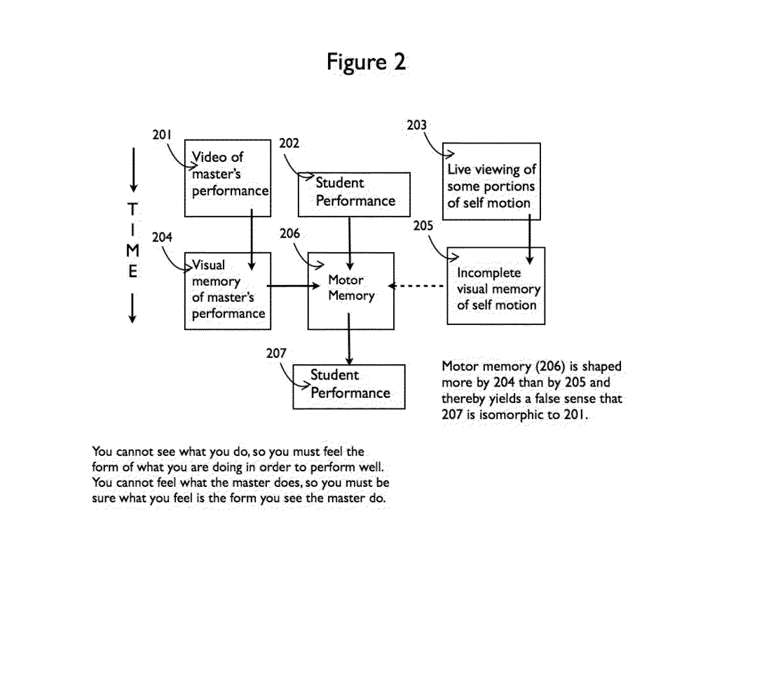

FIG. 3 shows the timing of visual and proprioceptive feedback when a student watches a live video of the self concurrently with a pre-recorded video of a master as proposed in the invention.

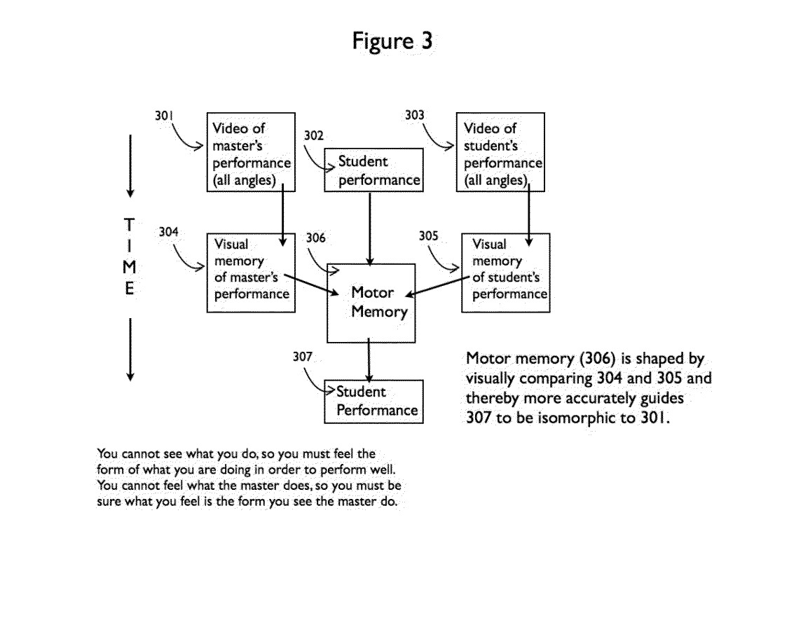

FIG. 4 shows the setup of one embodiment of the invention, a system that allows a tennis student to shadow a pre-recorded video clip of a tennis pro that plays on the computer in a window adjacent to a live video feed of the student.

FIG. 5 represents a very basic version of the computer interface that a tennis student uses to control the learning experience.

### DETAILED DESCRIPTION OF PREFERRED EMBODIMENTS OF THE INVENTION

In the following descriptions, embodiments of the invention relating to the improvement of playing tennis will be described. While this is one application of the invention, it will be understood that such embodiments are described by way of example only, and in other embodiments of the invention, other skilled motions could be the subject of study, such as dance steps, fielding a baseball, tae kwon do forms, and the correct form of physical exercises.

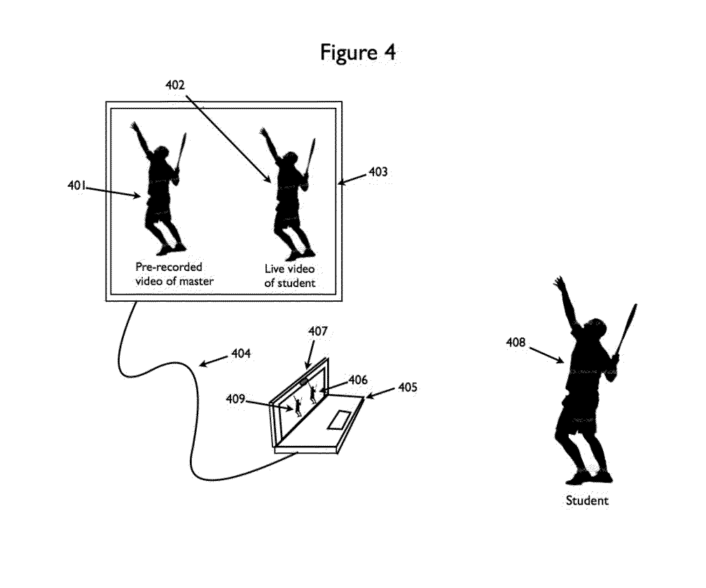

As seen in FIG. 4, as one embodiment of the invention, a tennis student (408) repeatedly shadow swings without a ball as he watches the pre-recorded video clip of the master (e.g., tennis pro) that plays on the screen of a laptop computer (405) on the left side of the computer screen (409). Concurrent to the action seen on the left side of the computer screen (409) the student (408) can see his own performance as a live video feed captured by the video camera (407) built into the frame of the laptop computer (405) and displayed on the right side of the computer screen (406). To improve viewing of the laptop video images (406 and 409) the laptop computer sends a video feed to a large digital video monitor (403) through a cable (404). Other embodiments could use wireless connections from a laptop or touch tablet computer to a video monitor or a cable connector to a video projector. The student can move the laptop (405) to any angle so that the built-in camera (407) captures the same perspective (406, 402) as seen in the prerecorded video clip of the master (409, 401). In this way the student (408) does not need to face the camera (407) in order to view the two video windows (401, 402) in the monitor (403) which affords the opportunity for the student (408) to view perspectives (e.g., rear or side) that are not possible to view using a conventional mirror.

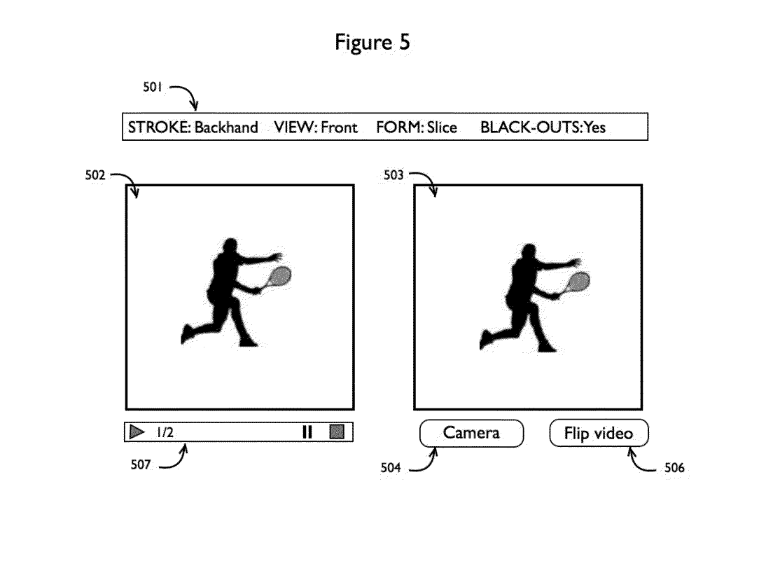

The student can control the learning experience via an interface on the computer screen. The student first sees a large directory of video clips organized by tennis stroke and other attributes such as perspective, gender of tennis pro, R-L orientation of tennis pro, variations on the style of the tennis stroke, and variations on duration of blacked-out segments of the pre-recorded video clips. These video clips could reside in an off-site server that the student accesses through an internet browser or could be accessed via a DVD-ROM. Once the student selects the clip that he wants to practice, the student sees the screen layout presented in FIG. 5.

FIG. 5 shows the pre-recorded video window of the tennis pro on the left side (502) and a video window of the live feed of the student on the right side (503). The caption bar at the top (501) shows the selected attributes of the pre-recorded video (502) such as the name of tennis stroke, perspective of the camera relative to the pro, particular variations on the style of the tennis stroke, and the presence or absence of blacked-out segments to encourage the student to cross-check the feeling of the desired form with and without the visual guidance of the pro. The blacked-out segments encourage the student to compare both sources of visual feedback (502 and 503) to better map what she sees to what she does.

Below the video window on the right (503) are two buttons the student can activate from the computing device keyboard, mouse, or remote control. The button marked “flip video” allows the student to change the R-L orientation of the video of herself (503). In this way the student's video image behaves in the same manner as a mirror image, making it easier to shadow swing the movements of the pro. The student can select from the video library either a right-hand version or a left-hand version of the pro (502).

In order to keep the student's focus on the whole form and flow of the tennis stroke, the student will shadow swing without hitting a tennis ball. The tennis pro will be seen hitting a ball. High frequency shadow swings without a ball are supported by many tennis coaches as the best way to build motor memory for the complete form of an expert motion.

In this embodiment and in alternative embodiments, students will be able to practice the skilled motion at home, indoors, and without the presence of a personal coach. Such an embodiment combines the objective of improving the tennis stroke as well as increasing the heart rate in what can easily be a healthy aerobic exercise.

The tennis pro video (502) will loop repeatedly until the student clicks on the video control bar (507) to stop. The student can control any number of playback features for the pre-recorded video (502) that are state-of-the-art standards for digital video players, such as freeze frame, ½ playback speed, and single frame advance.

The student can access from the video library tutorials on the rationale and use of the blacked-out segments of the pre-recorded video, suggestions on why and how to change the perspective of the camera relative to the student, guidance on how to take a holistic view when practicing, and other possible topics.

It should be apparent that various changes and modifications to the embodiments mentioned herein will be apparent to those skilled in the art. Such changes and modifications may be made without departing from the spirit and scope of the invention and without diminishing its attendant advantages. It is therefore intended that such changes and modifications be included within the present invention.

1. A method of instruction to teach a skilled motion comprising the student performing the motion while watching a live video of the self performing the motion displayed side-by-side and simultaneously with a pre-recorded video of a master performing the skilled motion.

2. A preferred embodiment of claim 1 comprising a video camera, a computing device, and a display device, wherein:
The display devices of claim 1 comprising a computer screen, a video projector, a video monitor, or video glasses.
The video camera of claim 1 comprising a video camera detached from the computing device and/or a video camera built into the computing device. The computing devices of claim 1 comprising, but not limited to, tablet
computers, laptop computers, desktop computers, hand-held devices, and wearable devices.
The embodiments of claim 1 comprising communication among these devices by cable and/or by wireless signals.

3. The means of claim 1 further comprising a computer interface that the student uses to control the learning experience via the computing device.

4. The means of claim 3 further comprising a searchable library of a plurality of pre-recorded video clips of a master performing skillful motions.

5. The means of claim 4 further comprising video clips in a plurality of perspectives (e.g., right, left, rear, front, aerial, macro shots), including right to left reversals, for each skilled motion of a master that present at least three continuous and successive variations of each skilled motion performed by both male and female masters using the objects, if appropriate, associated with the skilled action under study.

6. The means of claim 3 further comprising playback features of the pre-recorded video under the student's control that may be executed by direct interactions with the computing device and/or by a remote control.

7. The means of claim 6 further comprising a control for the student to start and stop the video of the master that loops continuously as the student performs that skilled motion repeatedly as long as desired.

8. The means of claim 6 further comprising a means for the student to control the onset and duration of blacked-out segments of the pre-recorded video clips of the master as that video continues to loop alternating between visible content and the blacked-out segment.

9. The means of claim 6 further comprising a means for the student to reorient the horizontal orientation of the live video of the student performing the skilled motion.

10. The means of claim 6 further comprising a means for the student to use digital video controls well known in the art, including pausing, slowing playback, single frame advance, and freezing frames of the pre-recorded video file. These standard controls include total screen capture of all of the action of both video streams (406 and 409) stored to disk for later viewing.

11. The means of claim 3 further comprising a means to initialize and activate the built-in or external video camera in order to display the student's live performance of the skilled motion.

12. The means of claim 3 further comprising a set of video tutorials on how to use the unique features of this teaching method, for example in the embodiment of teaching tennis, the benefits of shadow swings without a ball, learning skilled motions holistically, tips on how to angle the video camera to match the video of the student and the master, and why to use digital video controls known to the art such as freeze frame, slow motion, copy frame, and recording screen action to disk.

13. The means of claim 1 comprising a delivery system of the user interface and video library to the student in any extant or future form, including, but not limited to, streaming video from a customized webpage on the internet, downloading the user interface and digital video files, or receiving the user interface and video library on a storage disc.
